(19) United States
(12) Patent Application Publication
(10) Pub. No.: US 2024/0289416 A1
(43) Pub. Date: Aug. 29, 2024

(54) METHODS AND APPARATUS FOR ACCELERATING TRANSFORMS VIA SPARSE MATRIX OPERATIONS

(71) Applicant: Femtosense, Inc., San Bruno, CA (US)

(72) Inventor: Scott Henry Reid, San Francisco, CA (US)

(73) Assignee: Femtosense, Inc., San Bruno, CA (US)

(21) Appl. No.: 18/586,891

(22) Filed: Feb. 26, 2024

Related U.S. Application Data
(60) Provisional application No. 63/486,935, filed on Feb. 24, 2023.

(51) Int. Cl. G06F 17/14

(52) U.S. Cl. CPC G06F 17/141; G06F 17/147

(57) ABSTRACT

Methods and apparatus for accelerating transforms via sparse matrix operations. Conventional processing architectures use bit-reversed addressing and a “butterfly” operation to perform digital signal processing techniques (such as the FFT, DFT, DCT, etc.). However, bit-reversed addressing may also be performed as a single sparse matrix permutation; similarly, butterfly operations may also be represented as a number of multi-matrix multiplications. Exemplary sparse matrix processors can perform these operations locally with great efficiency. Importantly, instead of sending data from a machine learning (ML) co-processor to a DSP to perform signal processing functions (and then back to the ML co-processor); the entire sequence may be performed on a sparse ML processor. This may greatly improve system power consumption and may entirely obviate the need for a separate DSP in certain (e.g., embedded) systems.

### PRIORITY APPLICATIONS

This application claims the benefit of priority to U.S. Provisional Patent Application Ser. No. 63/486,935 filed Feb. 24, 2023 and entitled “METHODS AND APPARATUS FOR ACCELERATING TRANSFORMS VIA SPARSE MATRIX OPERATIONS”, the foregoing incorporated by reference in its entirety.

### RELATED APPLICATIONS

This application is related to U.S. patent application Ser. No. 17/367,512 filed Jul. 5, 2021, and entitled “METHODS AND APPARATUS FOR LOCALIZED PROCESSING WITHIN MULTICORE NEURAL NETWORKS”, U.S. patent application Ser. No. 17/367,517 filed Jul. 5, 2021, and entitled “METHODS AND APPARATUS FOR MATRIX AND VECTOR STORAGE AND OPERATIONS”, U.S. patent application Ser. No. 17/367,521 filed Jul. 5, 2021, and entitled “METHODS AND APPARATUS FOR THREAD-BASED SCHEDULING IN MULTICORE NEURAL NETWORKS”, and U.S. patent application Ser. No. 18/049,453 filed Oct. 25, 2022, and entitled “METHODS AND APPARATUS FOR SYSTEM-ON-A-CHIP NEURAL NETWORK PROCESSING APPLICATIONS”, each of which are incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### TECHNICAL FIELD

This disclosure relates generally to the field of processor acceleration. More particularly, the present disclosure is directed to hardware, software, and/or firmware implementations of addressing optimizations for certain types of algorithms.

### DESCRIPTION OF RELATED TECHNOLOGY

Incipient research is directed to so-called “neural network” computing. Unlike traditional computer architectures, neural network processing emulates a network of connected nodes (also referred to throughout as “neurons”) that loosely model the neuro-biological functionality found in the human brain.

In many applications, a processor transforms real-world sensor data (audio/visual information) to its frequency-domain representation using mathematical transforms (e.g., Discrete Fourier Transforms (DFTs) and Discrete Cosine Transforms (DCTs)). The frequency-domain representation may be provided to a neural network co-processor for analysis e.g., noise reduction/waveform recognition. In some cases, the results of the neural network analysis are provided back to the original processor to be transformed back to time-domain signals (e.g. via Inverse Discrete Fourier Transforms). Communicating large amounts of data between the processor and the neural network co-processor in this manner is inefficient (e.g., slow and power hungry).

### BRIEF DESCRIPTION OF THE DRAWINGS

FIG. 1 provides a graphical representation of operational complexity of a 4-point DFT operation relative to a single MAC operation and butterfly operation.

FIG. 2 provides equations for transform decomposition that are useful in explaining various aspects of the present disclosure.

FIGS. 3A and 3B graphically depicts permutation matrixes and their decompositions, useful in explaining various aspects of the present disclosure.

FIG. 4 provides a re-write of transform decompositions that are useful in explaining various aspects of the present disclosure.

FIG. 5 provides an example Fourier transform, useful in explaining various aspects of the present disclosure.

FIG. 6 is a graphical representation of different bit-wise formats for representing sparse arrays of data elements, in accordance with the various principles described herein.

FIG. 7 is a graphical representation of a variable length decomposition of an exemplary sparse matrix, in accordance with the various principles described herein.

FIG. 8 is a graphical representation of one core and memory subsystem of the exemplary multicore architecture, useful to illustrate aspects of the present disclosure.

FIG. 9 is a logical block diagram of one generalized apparatus 900, useful in accordance with the various principles described herein.

FIG. 10 is a logical block diagram of a generalized sparse matrix transform routine.

### DETAILED DESCRIPTION

In the following detailed description, reference is made to the accompanying drawings. It is to be understood that other embodiments may be utilized, and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without departing from the spirit or scope of the present disclosure. It should be noted that any discussion regarding “one embodiment”, “an embodiment”, “an exemplary embodiment”, and the like indicate that the embodiment described may include a particular feature, structure, or characteristic, and that such feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the features, structures, or characteristics of the given embodiments may be utilized in connection or combination with those of any other embodiment discussed herein.

Various operations may be described as multiple discrete actions or operations in turn, in a manner that is most helpful in understanding the claimed subject matter. However, the order of description should not be construed as to imply that these operations are necessarily order dependent. The described operations may be performed in a different order than the described embodiments. Various additional operations may be performed and/or described operations may be omitted in additional embodiments.

### Signal Processing Transforms

In mathematics, a “transform” maps a function from its original domain space into another domain space, where some of the properties of the original function might be more easily characterized and manipulated than in the original domain space. The transformed function can generally be mapped back to the original domain space using the inverse transform. As but one example, the Discrete Fourier Transform (DFT) maps a time-domain signal to a frequency-domain signal; the Inverse Discrete Fourier Transform (IDFT) maps a frequency-domain signal to a time-domain counterpart. The DFT has an optimized variant referred to as the Fast Fourier Transform (FFT). As another example, the Discrete Cosine Transform (DCT) is a variant commonly used in image and video processing because it does not include imaginary sine components. Still other transforms include wavelet transforms which are often used for signals which have similarity across different time scales. While the present discussion is presented in the context of a DFT computation, artisans of ordinary skill in the related arts will readily appreciate that many other transforms (e.g., multi-dimensional FFT/IFFT, real FFT (RFFT)/IRFFT, DCT/IDCT, non-radix-2 decimation, wavelet transforms, and/or any other low-displacement-rank transforms, etc.) have similar computational steps.

Consider a digital signal that is represented as an N sized array of elements xₙ for n=0, . . . , N−1. The DFT of xₙ may be expanded according to EQNS. 1-3:

$${X}_{k} = {\sum }_{n = 0}^{N - 1} {x}_{n} {e}^{- i \frac{2 π kn}{N}} \qquad EQN . 1$$

$${X}_{k} = {\sum }_{m = 0}^{\frac{N}{2} - 1} {x}_{2 m} {e}^{- i \frac{2 π k ( 2 m )}{N}} + {\sum }_{m = 0}^{\frac{N}{2} - 1} {x}_{2 m + 1} {e}^{- i \frac{2 π k ( 2 m + 1 )}{N}} \qquad EQN . 2$$

$${X}_{k} = {\sum }_{m = 0}^{\frac{N}{2} - 1} {x}_{2 m} {e}^{- i \frac{2 π k ( 2 m )}{N}} + {e}^{- i \frac{2 π k}{N}} {\sum }_{m = 0}^{\frac{N}{2} - 1} {x}_{2 m + 1} {e}^{- i \frac{2 π k ( 2 m )}{N}} \qquad EQN . 3$$

The representation of EQN. 3 may be further sub-divided into: a DFT of even elements of xₙ (EQN. 4); a “twiddle” factor (EQN. 5); and a DFT of odd elements of xₙ (EQN. 6).

$${𝔼}_{k} = {\sum }_{m = 0}^{\frac{N}{2} - 1} {x}_{2 m} {e}^{- i \frac{2 π k ( 2 m )}{N}} \qquad EQN . 4$$

$${T}_{k} = {e}^{- i \frac{2 π k}{N}} \qquad EQN . 5$$

$${𝕆}_{k} = {\sum }_{m = 0}^{\frac{N}{2} - 1} {x}_{2 m + 1} {e}^{- i \frac{2 π k ( 2 m )}{N}} \qquad EQN . 6$$

More directly, this simplifies to:

$${X}_{k} = {𝔼}_{k} + {T}_{k} {𝕆}_{k} \qquad EQN . 7$$

$${X}_{k + \frac{N}{2}} = {𝔼}_{k} - {T}_{k} {𝕆}_{k} \qquad EQN . 8$$

The inverse DFT (IDFT) is very similar to the DFT, and may be expressed as:

$${x}_{n} = \frac{1}{N} {\sum }_{k = 0}^{N - 1} {X}_{k} {e}^{i \frac{2 π k n}{N}} \qquad EQN . 9$$

By analogous manipulations, this simplifies to: an IDFT of even elements of Xₖ (EQN. 10); a “twiddle” factor (EQN. 11); and an IDFT of odd elements of Xₖ (EQN. 12).

$${𝕖}_{n} = {\sum }_{m = 0}^{\frac{N}{2} - 1} {X}_{2 m} {e}^{i \frac{2 π n ( 2 m )}{N}} \qquad EQN . 10$$

$${T}_{n} = {e}^{i \frac{2 π n}{N}} \qquad EQN . 11$$

$${𝕠}_{n} = {\sum }_{m = 0}^{\frac{N}{2} - 1} {X}_{2 m + 1} {e}^{i \frac{2 π n ( 2 m )}{N}} \qquad EQN . 12$$

$${x}_{n} = \frac{1}{N} ( {𝕖}_{n} + {T}_{n} {𝕠}_{n} ) \qquad EQN . 13$$

$${x}_{n + \frac{N}{2}} = \frac{1}{N} ( {𝕖}_{n} - {T}_{n} {𝕠}_{n} ) \qquad EQN . 14$$

A DFT of xₙ can be recursively performed with radix-2 decimation of the time-domain based on EQNS. 5, 7, 8 (or EQNS. 11, 13, 14 for an IDFT). As an example, a 4-point DFT would have a twiddle factors of

$${T}_{k} = {e}^{- i \frac{2 π k}{4}} ;$$

or more directly: T₀=1, T₁=−i, T₂=−1, and T₃=i. This would result in the following equations:

$$\begin{matrix}{X}_{0} = {x}_{0} + {x}_{1} + {x}_{2} + {x}_{3} \\ {X}_{1} = {x}_{0} - i {x}_{1} - {x}_{2} + i {x}_{3} \\ {X}_{2} = {x}_{0} - {x}_{1} + {x}_{2} - {x}_{3} \\ {X}_{3} = {x}_{0} + i {x}_{1} - {x}_{2} - i {x}_{3}\end{matrix}$$

The expressions may be re-arranged and sub-divided into sub-components that can be re-used. For example, (x₀+x₂) can be calculated once, and used twice:

$$\begin{matrix}{X}_{0} = ( {x}_{0} + {x}_{2} ) + ( {x}_{1} + {x}_{3} ) \\ {X}_{1} = ( {x}_{0} - {x}_{2} ) - i ( {x}_{1} - {x}_{3} ) \\ {X}_{2} = ( {x}_{0} + {x}_{2} ) - ( {x}_{1} + {x}_{3} ) \\ {X}_{3} = ( {x}_{0} - {x}_{2} ) + i ( {x}_{1} - {x}_{3} )\end{matrix}$$

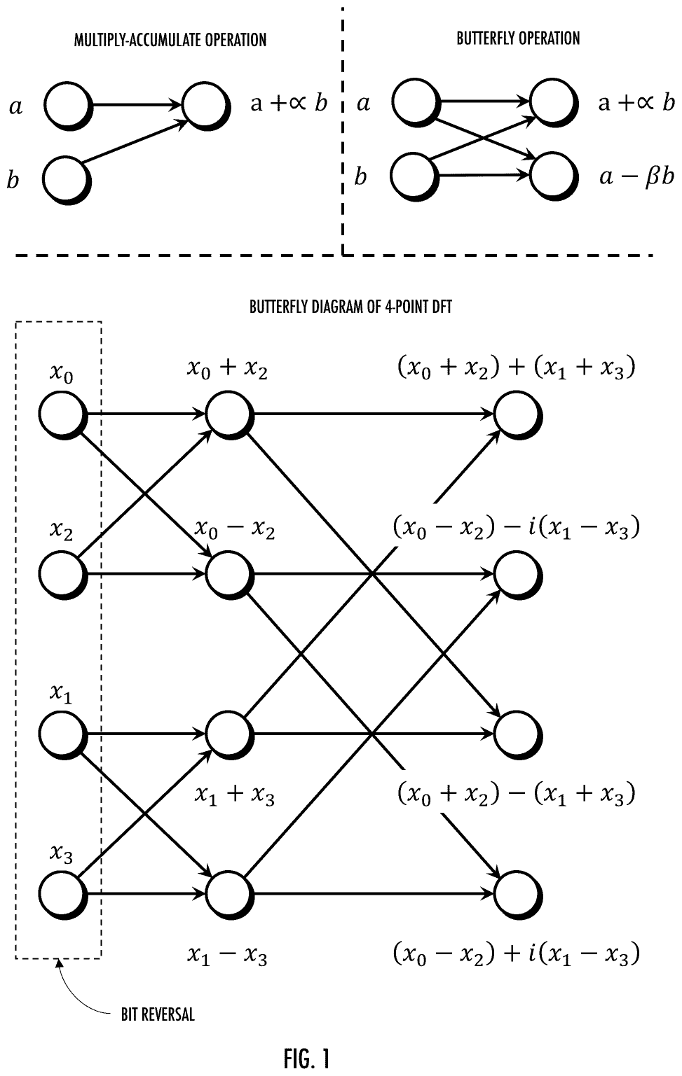

In the computing arts, the re-arrangement and re-use is grouped into pairs of MAC operations; this is colloquially referred to as a “butterfly” operation. FIG. 1 provides a visual depiction of the operational complexity of the 4-point DFT operation relative to a single MAC operation and butterfly operation. As shown, the 4-point DFT can be performed with 4 butterflies (8 MAC operations). More generally, for DFTs of size N, the operation may be performed within O(N log N) operations, where each stage has N/2 butterfly operations. In contrast, performing the DFT via a dense matrix-vector product requires O(N²) operations.

The foregoing optimization was originally discovered by James Cooley and John Tukey and forms the basis of the Cooley-Tukey Fourier Transform. While the Cooley-Tukey Fourier Transform may be generalized to any factorization of N, the most common implementations select N to be a power of two. These implementations are more commonly referred to as Fast Fourier Transforms (FFTs)). The FFT is widely used in engineering in virtually all signal processing applications (e.g., filters, audio/video processing, telecommunications, compression, encryption, signal analysis, etc.).

Referring back to FIG. 1, the input data stream for the DFT requires bit-reversed addressing. As shown, the array xₙ=[x₀ x₁ x₂ x₃] must be re-ordered [x₀ x₂ x₁ x₃]. While re-ordering could be done in software, most signal processing devices handle bit-reversed addressing with dedicated hardware (e.g., hardwiring the most significant bit of address becomes the least significant bit of address, etc.). TABLE 1 presents a side-by-side comparison of bit-reversed addressing.

TABLE 1

| 2-bit | | 3-bit | | 4-bit | |
|---|---|---|---|---|---|
| Addr. | BR Index | Addr. | BR Index | Addr. | BR Index |
| 00 | 00 = 0 | 000 | 000 = 0 | 0000 | 0000 = 0 |
| 01 | 10 = 2 | 001 | 100 = 4 | 0001 | 1000 = 8 |
| 10 | 01 = 1 | 010 | 010 = 2 | 0010 | 0100 = 4 |
| 11 | 11 = 3 | 011 | 110 = 6 | 0011 | 1100 = 12 |
| | | 100 | 001 = 1 | 0100 | 0010 = 2 |
| | | 101 | 101 = 5 | 0101 | 1010 = 10 |
| | | 110 | 011 = 3 | 0110 | 0110 = 6 |
| | | 111 | 111 = 7 | 0111 | 1110 = 14 |
| | | | | 1000 | 0001 = 1 |
| | | | | 1001 | 1001 = 9 |
| | | | | 1010 | 0101 = 5 |
| | | | | 1011 | 1101 = 13 |
| | | | | 1100 | 0011 = 3 |
| | | | | 1101 | 1011 = 11 |
| | | | | 1110 | 0111 = 7 |
| | | | | 1111 | 1111 = 15 |

As demonstrated above, dedicated hardware bit-reversed addressing can only handle a single fixed bit width. In other words, a 3-bit reversal (8-element array) does not correctly map to a 4-bit reversal (16-elements array), etc. Historically, signal processing has been application specific, thus fixed sizes have not been an issue. For example, an audio application might always use 128-bits of data (7-bits of address), etc.

As another important tangent, the 4-point DFT may also be re-written as a matrix operation:

$$[ \begin{matrix}{X}_{0} \\ {X}_{1} \\ {X}_{2} \\ {X}_{3}\end{matrix} ] = [ \begin{matrix}1 & 1 & 1 & 1 \\ 1 & - i & - 1 & i \\ 1 & - 1 & 1 & - 1 \\ 1 & i & - 1 & - i\end{matrix} ] [ \begin{matrix}{x}_{0} \\ {x}_{1} \\ {x}_{2} \\ {x}_{3}\end{matrix} ]$$

Notably, however, conventional computation of vector-matrix products are performed with an element-wise multiply-accumulate (MAC). Thus, a 4-element vector-matrix operation would take 4×4=16 MAC operations (i.e., scaling at N² operations), which is significantly greater than the 8 MAC operations for the conventional FFT (i.e., N log₂ N operations). The difference in complexity between O(N²) and O(N log₂ N) scales very rapidly as N increases. For example, a standard audio application might be on the order of N=256; thus, N² is roughly 66,000 which is much greater than N log₂ N (2048). In other words, the brute force execution of vector-matrix operations in conventional processing architectures would be far less efficient than the FFT.

### Exemplary Acceleration Via Sparse Matrix Processors

As previously alluded to, many neural networking applications integrate with real-world sensor data (audio/visual information) to process signals of arbitrary complexity. Unfortunately, communicating large amounts of sensor data between a primary processor and a neural network co-processor is both slow and inefficient. The arbitrary nature of the real-world sensor data is also difficult for fixed point accelerators; typically, the data must be “padded” with null data up to the fixed-point ceiling. As an unrelated, but important tangent, the “sparse” nature of neural networks has fueled advancements in vector-matrix processing which greatly improve on conventional “brute force” element-wise processing. Thus, conventional solutions for signal processing should be re-visited in view of the confluence of these developments.

Various embodiments of the present disclosure are directed to accelerating mathematical transforms natively within a sparse matrix accelerator. In one specific implementation, the sparse matrix accelerator uses a matrix permutation operation which re-orders input vectors akin to the bit-reversed addressing of the conventional FFT (with multiple important distinctions, discussed in greater detail below).

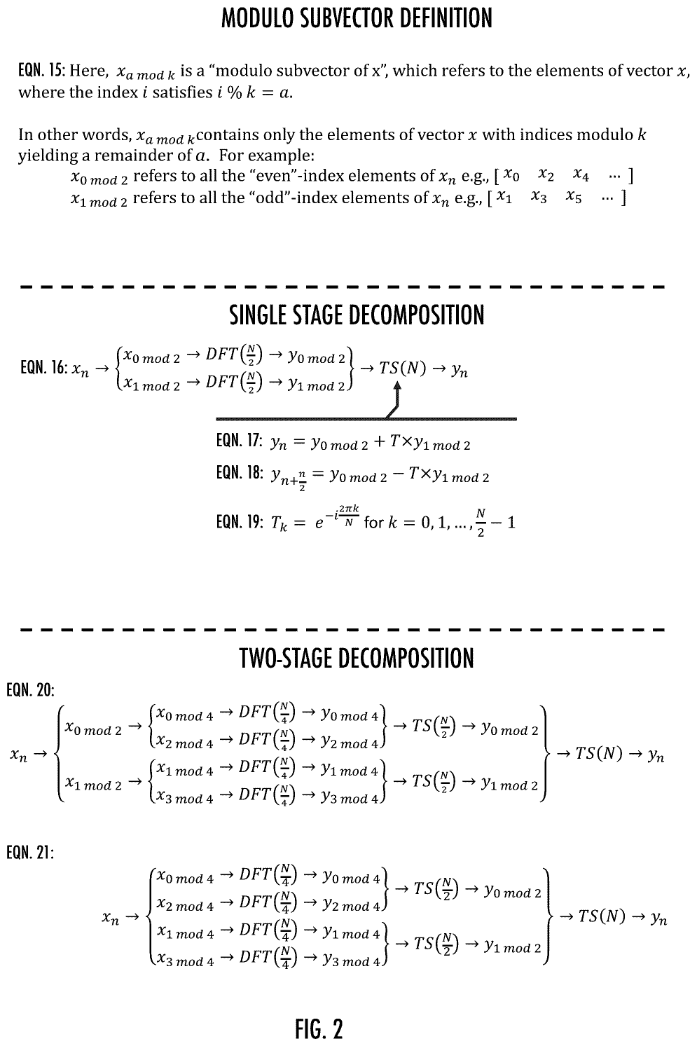

FIG. 2 provides equations that are useful in explaining various aspects of the present disclosure. EQN. 15 defines a modulo-k subvector nomenclature, useful to explain various aspects of the present disclosure. Using this nomenclature, a vector xₙ may be subdivided into its “even” and “odd” subvectors. Even and odd subvectors may be used to rewrite a single stage decomposition of a DFT of size N, as shown in EQN. 16. Here, the TS(N) (“Twiddle Stage”) operation corresponds to the operations of EQNS. 17-19, and

$$DFT ( \frac{N}{2} )$$

refers to dense multiplication by a DFT matrix of size N/2. Importantly, this represents a decomposition of a DFT of size N into two DFTs of size N/2, plus element-wise twiddle math. The complexity of the original DFT(N) is O(N²). With a single stage of decomposition, it is reduced to two smaller DFTs, each of complexity

$$O ( \frac{{N}^{2}}{4} ) ,$$

plus a twiddle stage of complexity O(N). All told, the complexity of this re-formulated decomposition is

$$O ( \frac{{N}^{2}}{2} + N ) .$$

Additional stages of decomposition may be performed by replacing each

$$DFT ( \frac{N}{2} )$$

operation with a single-stage DFT decomposition, etc. Thus, by extension, a two-stage decomposition may be written as shown in EQN. 20. Furthermore, the operation may be further simplified by directly extracting the modulo-4 subvectors of x without first needing to compute the modulo-2 subvectors, shown as EQN. 21.

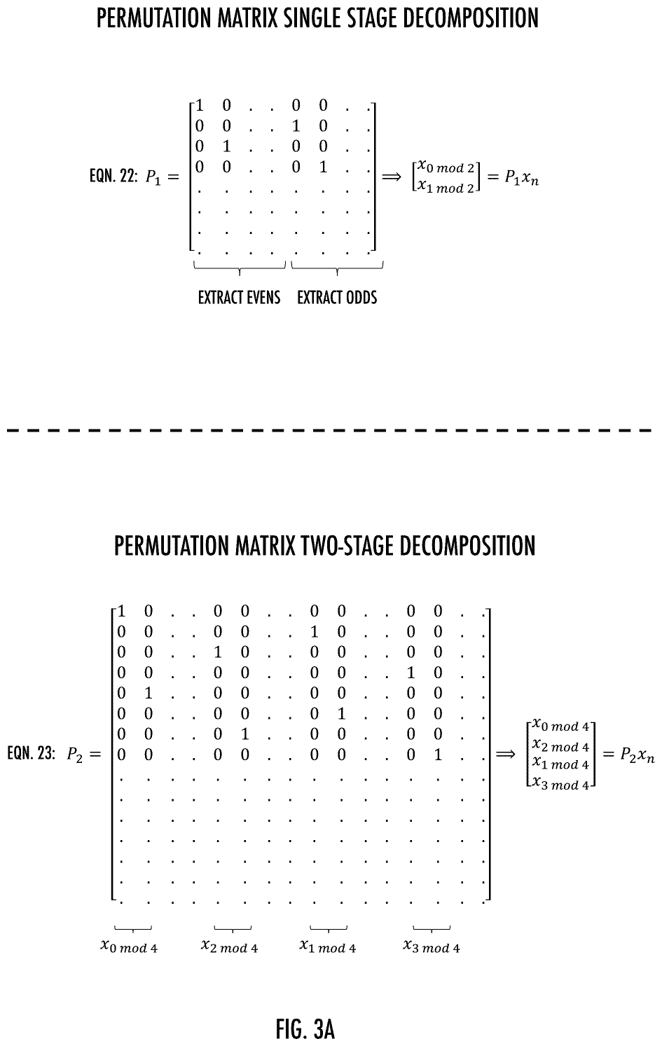

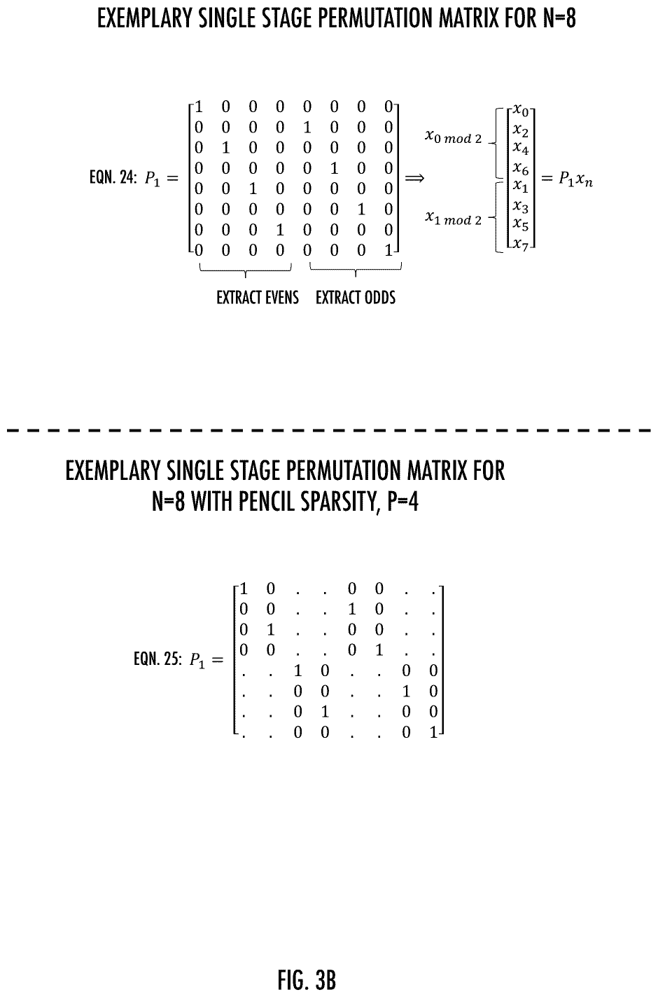

FIG. 3A shows that extracting the modulo-k subvectors of x may be mathematically simplified to a matrix-vector product with a single sparse permutation matrix. For example, the permutation matrix for a single-stage decomposition of arbitrary size to extract the modulo-2 subvectors (even and odd components) is expressed in EQN. 22. As shown, the first half of the matrix (columns 1 through N/2) corresponds to x_{0 mod 2} (the even elements of xₙ), and the second half of the matrix

$$( columns \frac{N}{2} + 1 through N )$$

corresponds to x_{1 mod 2} (the odd elements of xₙ). By extension, the permutation matrix for a two-stage decomposition of arbitrary size is given by EQN. 23. Where the first quarter of the matrix (columns 1 through N/4) corresponds to x_{0 mod 4}, the second quarter of the matrix

$$( columns \frac{N}{4} + 1 through \frac{N}{2} )$$

corresponds to x_{2 mod 4}, the third quarter of the matrix

$$( columns \frac{N}{2} + 1 through \frac{3 N}{4} )$$

corresponds to x_{1 mod 4}, and the last quarter of the matrix

$$( columns \frac{3 N}{4} + 1 through N )$$

corresponds to x_{3 mod 4}.

Importantly, the sparse permutation matrices of FIG. 3A include values of only “0” and “1”. Regions notated as “.” in FIG. 3A indicate the continuation of the sparse permutation pattern. An exemplary case is provided for a single-stage decomposition with N=2 in FIG. 3B. As shown, a non-null matrix (EQN. 24) may be grouped into “pencil” data structures (discussed in greater detail below); here, each pencil is a sub-column vector of length 4. Pencils that only have “0” elements may be converted to null pencils. The resulting matrix is shown in EQN. 25. Matrix elements denoted as “.” in EQN. 25 denote “null” elements of the matrix which are neither stored nor used during computation. As discussed in greater detail below, sparse processing logic may take advantage of null values and pencil data structures for additional efficiency gains.

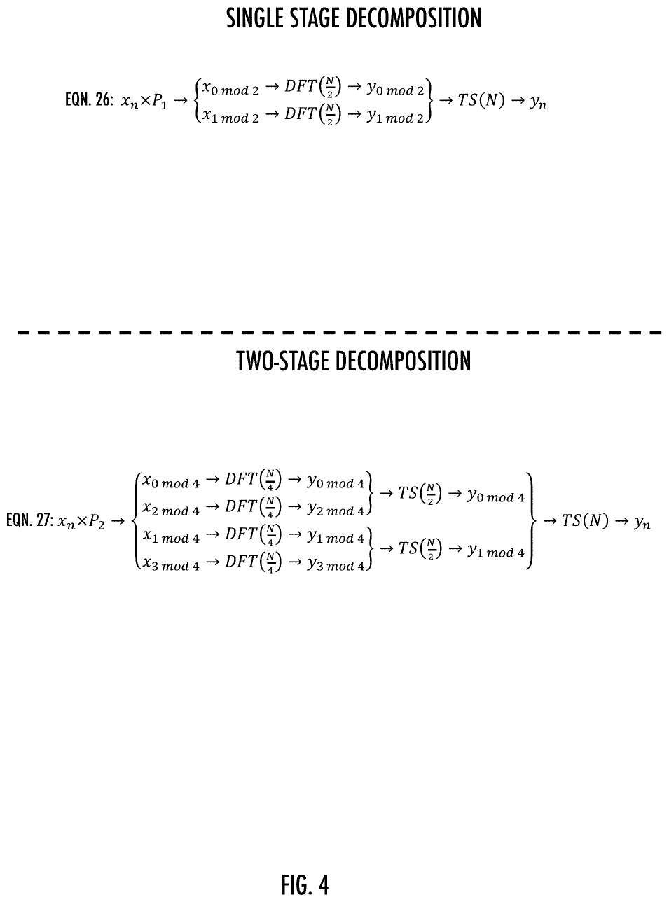

FIG. 4 summarizes the exemplary single stage decomposition and the two-stage decomposition with the modulo-k subvector nomenclature. As shown, a single-stage decomposition may be rewritten as EQN. 26 using the sparse permutation matrix P₁. Similarly, a 2^{nd} stage decomposition may be rewritten as EQN. 27 using the sparse permutation matrix P₂. While the modulo-k subvector nomenclature provides a concise notation, the underlying computation is a multi-matrix operation.

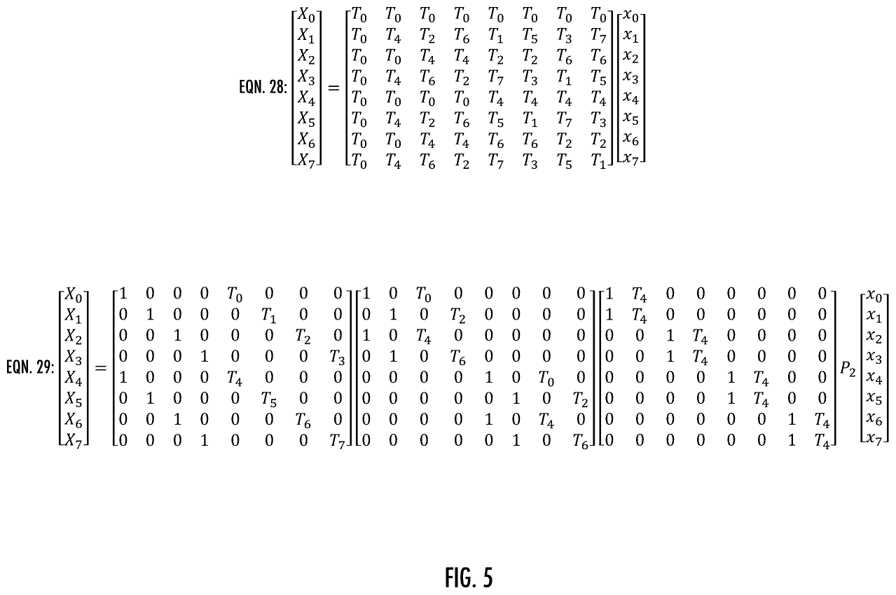

For reference, FIG. 5 depicts a two-stage decomposition of an 8-point DFT as a multi-matrix operation. Here, the 8-point DFT may be initially expressed as EQN. 28, which is then factorized to EQN. 29. As shown, the first matrix corresponds to the 1^{st} order Twiddle Stage (T(N)), the second matrix corresponds to two parallel 2^{nd} order

$$Twiddle Stages ( T ( \frac{N}{2} ) ) ,$$

and the third matrix corresponds to four parallel 2-point

$$DFTs$$

$$DFT ( \frac{n}{4} ) ) .$$

More generally, higher-order decompositions can be performed by adding more even/odd permutation stages prior to the DFT process (e.g., a 3^{rd} order decomposition would use 3 permutation stages to decompose to

$$DFT ( \frac{n}{8} ) ,$$

a 4th order decomposition would use 4 permutation stages to decompose to

$$DFT ( \frac{n}{16} ) ,$$

etc.). Yet, any number of permutation stages may be simplified to a single sparse permutation matrix. As previously noted, vector-matrix operations are inefficient when computed with a brute force element-wise vector-matrix multiply, however, an exemplary sparse matrix processor can leverage the sparsity of the single sparse permutation matrix to greatly simplify processing complexity.

In other words, rather than performing the permutation as a number of stages, a processor may perform a permutation directly (in a single step) by multiplying by a permutation matrix. As the permutation matrix is sparse, the vector-matrix multiplication may be accelerated on a processor that can accelerate sparse vector-matrix products in linear time, compared to a non-sparse accelerator. Additionally, where previously, data would be sent from a machine learning (ML) co-processor to a DSP to perform FFT functions (and then back to the ML co-processor); the entire sequence may be performed on a sparse ML processor. This may reduce the need for a separate DSP entirely in certain (e.g., embedded) systems.

### Exemplary Sparse Vector-Sparse Matrix Compressed Representations

As previously alluded to, conventional vector-matrix operations naïvely store, and brute force process, every matrix element in memory (whether null or not). Similarly, brute force calculation quadratically increases in complexity as a function of matrix size (regardless of the matrix's sparsity). In contrast, one exemplary embodiment compresses, and processes sparse data structures based on actual non-null data. The implementation described herein greatly reduces storage requirements as well as computational complexity. Sparse data structures that would otherwise exceed embedded device memory and/or processing constraints may be compressed to fit within much smaller memory footprints and/or run much more efficiently.

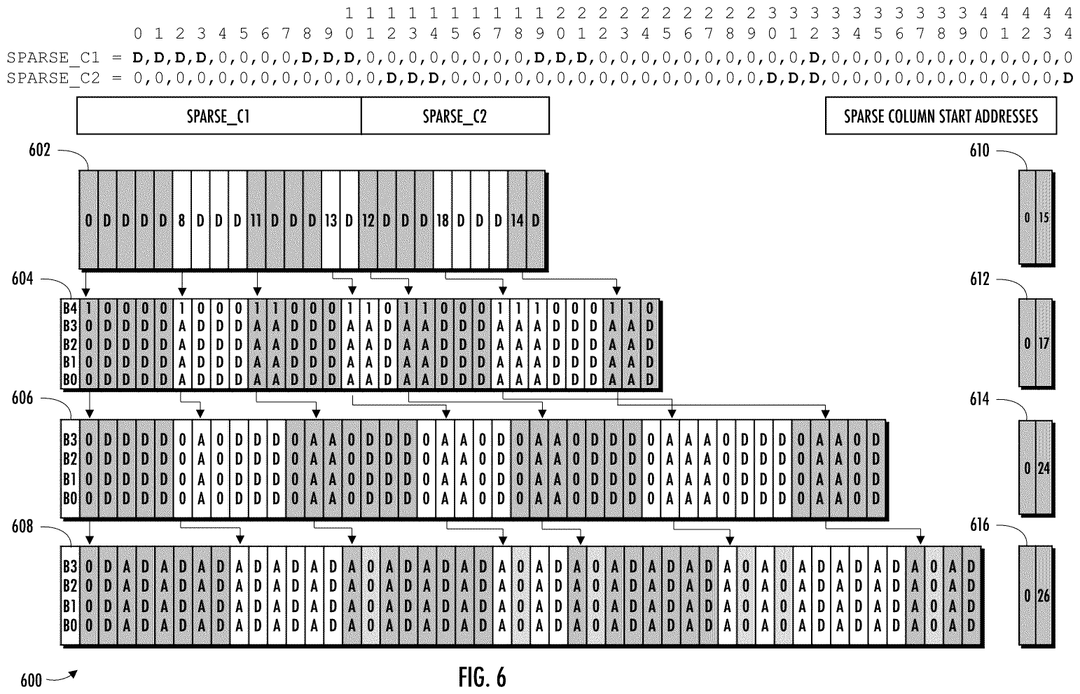

Sparse data structures may be compressed into a collection of values and their corresponding position or index within a data structure. Notably, there are overhead costs associated with compression, and different techniques have different costs and benefits. Referring now to FIG. 6, a graphical illustration 600 of different bit-wise formats for representing sparse arrays of data elements is shown. A sparse vector may be represented with a one-dimensional sparse array (e.g., like either SPARSE_C1 or SPARSE_C2), whereas a sparse matrix may be represented as multiple one-dimensional sparse column arrays (e.g., a first column SPARSE_C1, a second column SPARSE_C1), with corresponding sparse column start addresses. For example, Table 602 is a 2-column matrix composed of: SPARSE_C1 with a first column offset of 0, and SPARSE_C2 with a second column offset of 15. Non-null data is denoted by a D; address offsets, where applicable, are denoted with an A.

In one exemplary embodiment, the sparse arrays group (mostly) non-zero values together in non-null consecutive sets, or “pencils” (instead of arbitrary mixtures of zero and non-zero elements). A pencil is a Px1 data structure, where P is less than the sparse array's dimension (e.g., a row/column if the matrix, the total length of a vector). The pencil data structure “amortizes” (leveraging the additional overhead of the pencil data structure to reduce overall overhead (of storage of null values in a sparse matrix)) storage overhead of the compression scheme by grouping non-null valued data structures together. For example, a two-element pencil may be addressed with a single address rather than by addressing each element individually (reducing addressing overhead by half). As a related benefit, access locality may improve operational efficiency. Grouping parameters that are frequently accessed together within a pencil reduces access overhead.

As used herein, the terms “zero” and “non-zero” refer to numeric values which may be arithmetically calculated. In contrast, the term “null” refers to values that are skipped; “non-null” values are not skipped. In other words, a zero weight may be pruned to a null value or kept as a non-null value. For example, various implementations may select the value of P to optimize access locality for dimensionality, or vice versa. Larger P values reduce access overhead, while smaller P values can support higher dimensions. In one exemplary variant, pencil size may have variable length increments (e.g., two, four, eight, etc.) The variable length increments may be selected based on performance requirements; for example, six (6) non-zero parameter weights may be grouped into two pencils of length two (2) and four (4), three (3) and three (3), etc. to maximize dimensionality; alternatively, six (6) non-zero parameter weights may be represented with a single pencil of length eight (with two non-null zero values) to maximize access efficiency. In some such cases, pencil size may be parameterized within application and/or compiler preferences.

As shown in FIG. 6, different columns of a sparse matrix may vary in non-null content (e.g., SPARSE_C1 and SPARSE_C2 have a different number of non-null elements). In “fixed offset addressing” implementations, the columns may be fixed in size (e.g., according to the largest column) to reduce column addressing complexity. Such implementations may be useful where the columns are substantially similar in non-null content (e.g., to balance column content), where the performance loss attributed to null calculations is less than “variable length addressing”, or where memory and computational complexity are flexible (e.g., time insensitive applications). In variable length addressing schemes, a parameter memory stores the start address or offset of each column (shown in tables 610, 612, 614, and 616). This scheme is more space efficient for columns that have substantial variations in non-null content, but also requires an additional step of indirection to de-reference each column's data elements. In some variants, the sparse column start addresses may be stored separately from column data (e.g., in a dedicated memory) to facilitate access.

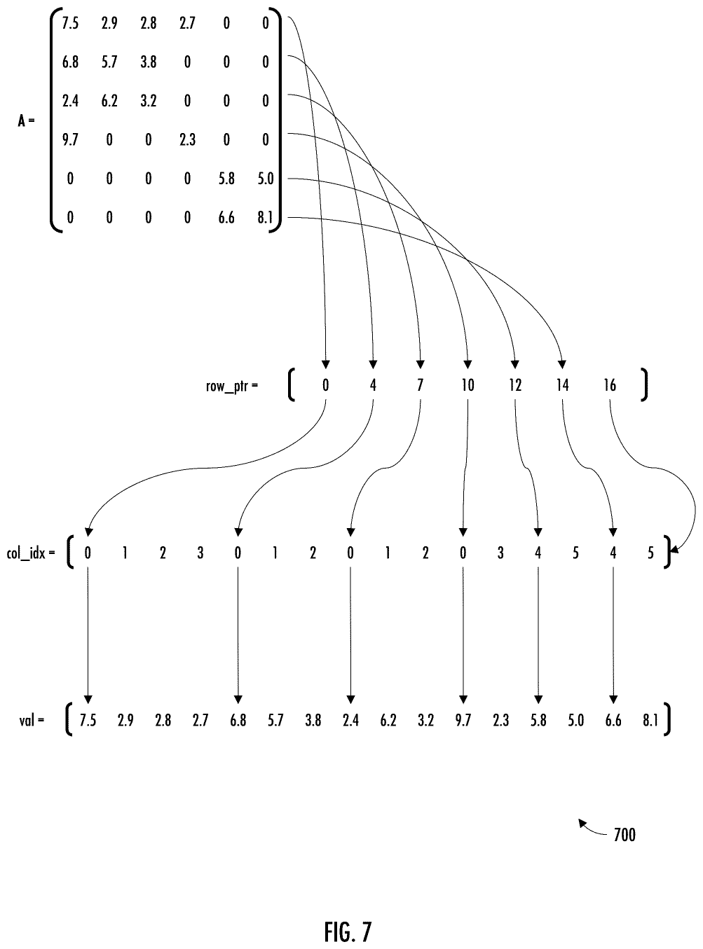

As but one such example, consider the variable length decomposition of the sparse matrix depicted within FIG. 7. As shown therein, each of the non-null entries is stored in a compressed array (val). A row_ptr array stores the first entry of each row; a col_idx array stores a corresponding column index (within the row) for each of the non-null entries. To traverse this compressed data structure to any entry (val) within the sparse matrix: start at the top left of the matrix; go row_ptr entries from left to right. Wrap to the next row down upon reaching the end of the current row; and go col_idx entries further. For example, to de-reference the value at A_{5,6}, the 5th index of row_ptr is 12 (row 5), the 2^{nd} value indicates that column 6 (5^{th} index) has an associated value; therefore, the 14^{th} location of val stores the de-referenced value 5.0. Notably, this scheme immediately identifies the presence of a null position; e.g., de-referencing A_{5,1} returns a null value (the first non-null value in row 5 is the 4^{th} index (5^{th} position)).

Referring back to FIG. 6, three different bit-wise formats are presented: a first format that uses an extra bit (B4) to distinguish data from address offsets (table 604), a second format that uses all-o data-address offset separators (table 606), and a third format that uses data-address offset pairs with all-o separators (table 608). In some embodiments sparse vectors and sparse matrices use the same compression scheme. For example, both sparse vectors and sparse matrices may be represented using the compression scheme illustrated in table 608 (and sparse column start address table 616). In other embodiments, different compression schemes are used for sparse vectors and sparse matrices. For example, sparse vectors may be represented using the compression scheme illustrated in table 604 while sparse matrices may be represented using the compression scheme illustrated in table 606 (and sparse column start address table 614).

Selection of the bit-wise storage format for sparse vectors and matrices may be based on hardware requirements (e.g., size of the ALU, addressing capacity) and/or based on the data (e.g., patterns in the data itself, such as clustering of non-null data, may lend itself to more efficient storage using different compression schemes). In some embodiments, a processor may use different compression schemes to accommodate different degrees of sparsity, more/less frequent access, and/or access latency/throughput. In some variants, the processor may support multiple different functionalities with different instruction sets; the selection of the appropriate format (and corresponding instructions) may be based on the application requirements. For example, a sparse matrix that prefers immediate access to data/address may perform well with the first format 604 since the extra flag bit (B4) is retrieved at the same time as data and address. In other cases, large pencils of data may be better served with format 606 since a single address can be used for multiple data entries. Still other implementations that are less well grouped may prefer format 608 since each data has a corresponding address.

Table 602 is a logical representation of a 2-column matrix where the first column (offset 0) includes four (4) pencils at relative column offsets of 0, 8, 11, and 13 (SPARSE_C1); the second column (SPARSE_C2) has three (3) pencils at relative column offsets of 12, 18, and 14. For example, Table 602 starts with a 0, which indicates that the first value (at location 0) in SPARSE_C1 is a data value. The second group of data values is at word 8 (which is 8 more than 0), then word 19 (which is 11 more than 8), and then word 32 (which is 13 more than 19). As sparse column start address table 610 indicates, the SPARSE_C2 column begins at the 15^{th} position of the larger combined data structure. In SPARSE_C2, the first data value is at word 12, the second group of data values is at word 30 (which is 18 more than 12), and the last is at word 44 (which is 14 more than 30).

Table 604 illustrates a first compression scheme that uses an additional bit (B4) to indicate whether the value represented by bits [B0:B3] is a data entry (D, flagged by a 0) or address offset entry (A, flagged by a 1). A corresponding sparse column start address table 612 indicates that SPARSE_C1 column begins at position 0 and SPARSE C2 column begins at position 17 of the data structure. In this implementation, each word in table 604 has 5 bits, however in other embodiments words may be larger (e.g., 9 bits for an 8-bit pencil, 17 bits for a 16-bit pencil) or smaller (e.g., 3 bits for a 2-bit pencil). Alternative implementations may e.g., reverse the flag meaning (addresses use 0, data uses 1) or otherwise modify the position of the flag (e.g., in the LSB rather than the MSB), etc. Still other implementations may combine multiple consecutive address offset entries to represent offsets larger than 15 (the largest value represented by 4 unsigned bits when zero is included); consecutive entries could be summed or have their bits concatenated to represent the larger offset. In such variants, a value of B4:B0 of 10000 (or similar flag) may also be used to indicate the start of a new column for the parameter memory.

Table 606 illustrates a second compression scheme that uses all-zero data address offset separators. In this scheme, data and address fields may alternate with the all-zero separator. In the illustrated embodiment, address fields follow data fields, however, in other embodiments, the data fields follow address fields. In this implementation, the sparse column start address table 214 indicates that the SPARSE_C1 column begins at position 0 and SPARSE_C2 column begins at position 24 of the larger combined data structure (reflecting the increase in words/pencils). In one such implementation, starting with the same type of entry (e.g., an all zero delimiter, or a data entry) allows the hardware to treat every column the same; e.g., the hardware does not need logic to check whether the first entry is a delimiter or data. Other implementations may use hardware logic to robustly determine the column entry types (e.g., this may be useful where data may be malformed, etc.).

Table 608 illustrates a third compression scheme that alternates between data and address offset entries. If an offset is larger than representable by a single address offset entry (one word), then an all-zero entry indicates that the next entry is also an address offset. The first word (that is not all-zeros) is data and the second word is an address (unless the escape word of all zeros is used). In one embodiment, the first non-null entry offset may be relative to the top left of the matrix, however one of ordinary skill would understand that such an offset may be relative to any corner or portion of the matrix. In another embodiment, another data “window size” is (pre-)selected and 2, 3, 4, etc. data entries may be followed by an address unless escaped. Sparse column start address table 616 indicates that the SPARSE_C1 column begins at position 0 and SPARSE_C2 column begins at position 26 of the larger combined data structure (reflecting the increase due to all-zero words/pencils).

As previously alluded to, the vectors and matrices are used differently in vector-matrix operations. For example, the exemplary sparse matrices described herein include links to compressed column data structures, where each compressed column data structure stores mostly non-null entries (large runs of null entries are skipped). Similarly, the exemplary sparse vector addressing schemes described below skip most nulled entries. Conceptually, the skipped entries represent operations that may also be skipped (rather than computing a null result). Various other data structure considerations are explored in U.S. patent application Ser. No. 17/367,517 filed Jul. 5, 2021, and entitled “METHODS AND APPARATUS FOR MATRIX AND VECTOR STORAGE AND OPERATIONS”, previously incorporated by reference in its entirety.

### Exemplary Sparse Matrix Processor

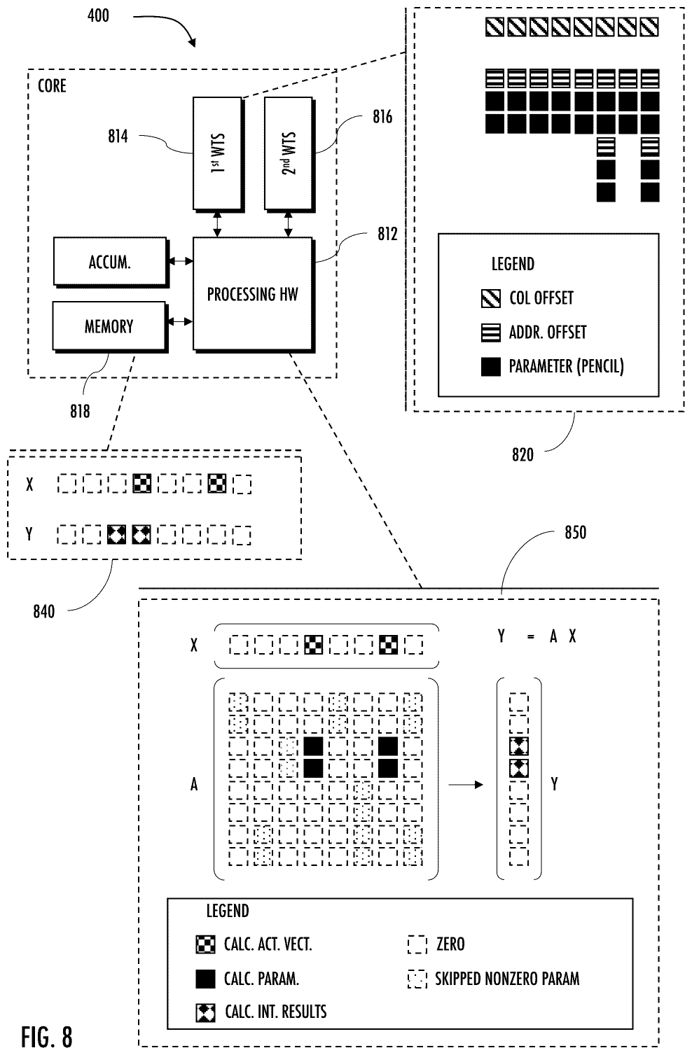

FIG. 8 is a graphical representation of one core and memory subsystem 800 useful to illustrate various aspects of the present disclosure. As shown therein, the core includes processing hardware 812 that is tightly coupled to: (i) a memory 814 that stores a first set of weights (such as add/twiddle weights) (ii) a memory 816 that stores a second set of weights, and (iii) a working memory 818. Register-based operation may be slightly faster than memory-based operation, whereas memory-based operation may offer more flexible addressing. Additionally, registers can be inexpensively manufactured to different degrees of precision (e.g., representing more bits) than entries in memory banks; this may be particularly useful for storing intermediate results. Thus, in some variants, the working memory 818 stores input and output vectors (x, y) for an operation, and an accumulator stores intermediate results of the operation within a vector register. In other variants, the memory 818 stores input, output, and intermediate result vectors. Still other memory/register variations may be substituted with equal success by artisans of ordinary skill in the related arts, given the contents of the present disclosure.

In one embodiment, the weights are stored according to the aforementioned all-o data-address offset separator format (see e.g., table 608 of FIG. 6); a graphical illustration of the compressed storage is provided in breakout 820. As shown therein, the sparse matrix representation provides a substantially more compact representation than storing the entire matrix (N×N). Specifically, the sparse matrix only requires O(M) complexity (where M is the non-null elements plus offset overhead). For example, a matrix that is only 10% non-null values may be compressed to nearly a tenth of the size (assuming negligible offset overhead).

As a further optimization, the working memory (breakout 840) provides ready access to the subset of compressed vector data that is needed for the computation. As is illustrated in FIG. 8, the sparse vector and sparse matrix data structures are not decompressed for computation. In other words, the data formats described above facilitate lookups based on parameter validity/invalidity and element-wise computation of valid parameters.

Since sparse vectors and matrices have many nulls, the exemplary implementation efficiently accesses only non-null values that may affect the final output (breakout 850). In other words, a null value in either the vector or the matrix can be skipped. In the exemplary embodiment, the core skips null operations based on the vector positions (null value positions). For example, if the first three entries of the vector are null, then the first three parameters of any column may be skipped. Additionally, for each non-null vector entry, the core only performs element-wise operations where there are corresponding pencil data structures (e.g., non-null parameter data). In the illustrated example, only the 4th and 7th column have a pencil data structure that corresponds to the 4th position. Consequently, only two (2) intermediate results need to be calculated.

Using the aforementioned sparse matrix format to store a permutation matrix, followed by small parallel DFTs and multiple parallel twiddle stages results in an efficient and flexible FFT decomposition, without using hard-coded bit-reverse addressing hardware or butterfly hardware. For a DFT of size N, the overall complexity is reduced to

$$O ( \frac{{N}^{2}}{{2}^{M}} + ( M + P ) N ) ,$$

where M is the number of stages of decomposition and P is the pencil-size used for the sparse permutation matrix. A DFT of size N can be decomposed up to a maximum of M*=log₂ N stages. At this maximum decomposition, the complexity of the FFT is O(N log₂ N+(P+1)N). For practical pencil-sizes and FFT sizes (e.g., P=4, N=512), the linear overhead of performing the FFT in this manner is negligible.

Various other processor considerations are explored further in U.S. patent application Ser. No. 17/367,517 filed Jul. 5, 2021, and entitled “METHODS AND APPARATUS FOR MATRIX AND VECTOR STORAGE AND OPERATIONS”, previously incorporated by reference in its entirety.

### System Architecture

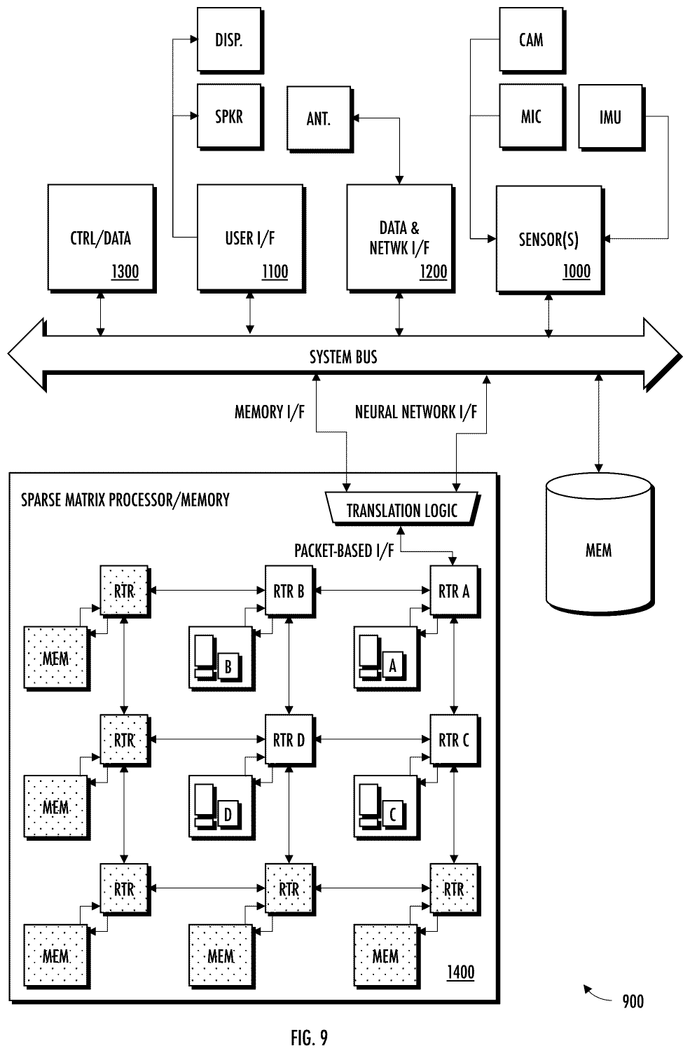

FIG. 9 is a logical block diagram of one generalized apparatus 900, useful in accordance with the various principles described herein. The apparatus 900 may be functionally divided into: a sensor subsystem 1000, a user interface subsystem 1100, a data/network interface subsystem 1200, a control and data subsystem 1300, and a bus to enable data transfer.

In one specific implementation, the control and data subsystem additionally includes a machine learning subsystem 1400 which may include a sparse matrix processor and/or memory.

The following discussion provides a specific discussion of the internal operations, design considerations, and/or alternatives, for each subsystem of the generalized apparatus 900.

### Sensor Subsystem

Functionally, the sensor subsystem senses the physical environment and captures and/or records the sensed environment as data. The illustrated sensor subsystem includes: a camera sensor, a microphone, and an inertial measurement unit (accelerometer, gyroscope, magnetometer).

A camera lens bends (distorts) light to focus on the camera sensor. The camera sensor senses light (luminance) via photoelectric sensors (e.g., CMOS sensors). Typically, a color filter array (CFA) value provides a color (chrominance) that is associated with each sensor. The combination of each luminance and chrominance value provides a mosaic of discrete red, green, blue value/positions, that may be “demosaiced” to recover a numeric tuple (RGB, CMYK, YUV, YCrCb, etc.) for each pixel of an image.

An image is a digital representation of sensed light. Image data may refer to the raw image information (e.g., physical photosite values and chrominance information) or the demosaiced pixels. Pixel data is usually formatted as a two-dimensional array whereas raw image information may be physically irregular (corresponding to the physical photosite sizes and layouts).

A video is a sequence of images over time that conveys image motion. The individual images are also referred to as “frames”; frames are taken at specific moments in time (according to a frame interval or frame rate).

A “codec” refers to the hardware and/or software mechanisms for “encoding” and “decoding” media. A significant portion of codec processing is based on signal processing transforms such as the Discrete Cosine Transform (DCT). For example, most MPEG standards subdivide an image into 8 pixel by 8 pixel (8×8) blocks and/or macroblocks (16×16). The blocks are then transformed using a 2-dimensional DCT to obtain their (cosine) frequency components. The transformed image data can use correlation between adjacent image pixels to provide energy compaction or coding gain in the frequency-domain. The DCT uses many of the same mechanisms as the DFT, with slight differences in twiddle factors which are well known in the signal processing arts.

Additionally, due to the large amount of redundant information, most video frames may refer to information from other video frames. For example, so called “I-frames” are “intracoded” which means they contain a complete set of information to reproduce the frame. In contrast, “P-frames” are predicted from other frames (e.g., I-frames, P-frames, or B-frames); “B-frames” are bi-directionally predicted—e.g., they may reference information from frames that occur before or after the instant frame.

While present disclosure is described in the context of perceptible light, the techniques may be applied to other EM radiation capture and focus apparatus including without limitation: infrared, ultraviolet, and/or X-ray, etc.

A microphone senses acoustic vibrations and converts the vibrations to an electrical signal (via a transducer, condenser, etc.) Typically, additional filtering and noise reduction may be performed to compensate for microphone characteristics. The resulting audio waveform may be compressed for delivery via any number of audio data formats. Audio data formats often rely on the Discrete Fourier Transform (DFT), Fast Fourier Transform (FFT), and/or other spectral transforms.

Microphones have a wide array of physical configurations. While the foregoing techniques are described in the context of a single microphone, multiple microphones may be used to collect stereo sound and/or enable audio processing. For example, any number of individual microphones can be used to constructively and/or destructively combine acoustic waves (also referred to as beamforming). Furthermore, different microphone structures may have different acoustic characteristics; for example, boom and/or shotgun-style microphones have different characteristics than omnidirectional microphones.

While present disclosure is described in the context of perceptible sound, the techniques may be applied to other acoustic capture and focus apparatus including without limitation: seismic, ultrasound, etc.

The inertial measurement unit (IMU) includes one or more accelerometers, gyroscopes, and/or magnetometers. These measurements may be mathematically converted into a four-dimensional (4D) quaternion to describe motion.

Typically, an accelerometer uses a damped mass and spring assembly to measure proper acceleration (acceleration in its own instantaneous rest frame). In many cases, accelerometers may have a variable frequency response. Most gyroscopes use a rotating mass to measure angular velocity; a MEMS (microelectromechanical) gyroscope may use a pendulum mass to achieve a similar effect by measuring the pendulum's perturbations. Most magnetometers use a ferromagnetic element to measure the vector and strength of a magnetic field; other magnetometers may rely on induced currents and/or pickup coils. The IMU uses the acceleration, angular velocity, and/or magnetic information to calculate quaternions that define the relative motion of an object in four-dimensional (4D) space. Quaternions can be efficiently computed to determine velocity (both device direction and speed).

While present disclosure is described in the context of quaternion vectors, artisans of ordinary skill in the related arts will readily appreciate that raw data (acceleration, rotation, magnetic field) and any of their derivatives may be substituted with equal success.

Furthermore, while the foregoing discussion is presented in the context of a specific set of sensors, any sensor or sensing technique may be substituted with equal success. Additionally, other sensor subsystem implementations may multiply, combine, further sub-divide, augment, and/or subsume the foregoing functionalities within these or other subsystems. For example, microphones may be used in conjunction with the user interface subsystem to enable voice commands. Similarly, an infrared transmitter/receiver of the data/network interface subsystem may also be used to e.g., sense heat, etc.

In the context of the present disclosure, sensor data may be sampled according to time, space, frequency, or other domain. As used herein, the term “time-domain” refers to representation of a signal as a function of time. As used herein, the term “frequency-domain” refers to representation of a signal as a function of frequency. More generally, the term “domain” and its linguistic derivatives refers to representations of a signal according to a basis. For example, an image may represent pixel values as a function of coordinate space (a spatial domain); similarly, a wavelet-domain might represent a signal as a function of its constituent wavelets, etc.

Different domains may have unique characteristics that can represent waveforms and/or perform manipulations more or less efficiently. As a result, transitions between domains (commonly used in intermediate data formats) are lossy. For example, an acoustically sampled impulse (a “pop”) may be sampled in the time-domain, however its frequency-domain counterpart may have an infinite number of spectral coefficients. Converting the time-domain audio samples to frequency domain coefficients may impose fidelity limitations, etc.

Furthermore, a variety of different signal processing techniques are used for analyzing and manipulating sensor data. While filtering techniques can be performed in different domains; many filters are more efficiently computed in a specific domain. For example, many filters (e.g., low-pass, high-pass, band-pass, notch, etc.) may be efficiently handled in the frequency-domain but would be much more difficult to perform in the time-domain.

In one embodiment, the sensor data may include time-domain samples. For example, audio data may be transferred as audio samples (fixed bit width, captured at a specific sample rate). In other embodiments, the sensor data may include spatial-domain samples. For example, image data may be transferred as a two-dimensional array of pixel values. Still other embodiments may transfer data as a compressed and/or variable bit width format. For example, video data may be transferred as encoded video frames of varying size for each frame-here, the video data may include frequency-domain components based on inter-frame similarities (similarities across different frames) and/or intra-frame similarities (similarities between different portions of the same frame). Furthermore, while the foregoing examples are all presented in the context of sample data, so-called “metadata” (data about data) and/or other forms of derived data may be substituted with equal success.

Direct access implementations may operate in parallel with, or independent from, other components of the control and data subsystem 1300. As but one such example, the machine learning subsystem 1400 may directly read audio/visual data from the sensor subsystem 1000, without e.g., an image signal processor (ISP), digital signal processor (DSP), graphics processing unit (GPU), and/or central processing unit (CPU), etc. In some embodiments, this may enable machine-specific applications that do not interfere with user experience or may even augment ongoing user applications—e.g., voice recognition may run in the background while the user is also using the microphone for other tasks, etc. In other embodiments, this may enable very low-power operations (e.g., without requiring booting a high-level operating system, etc.).

### User Interface Subsystem

Functionally, the user interface subsystem 1100 presents media to, and/or receives input from, a human user. In some embodiments, media may include audible, visual, and/or haptic content. Examples include images, videos, sounds, and/or vibration. Visual content may be displayed on a screen or touchscreen. Sounds and/or audio may be obtained from/presented to the user via a microphone and speaker assembly. Additionally, rumble boxes and/or other vibration media may playback haptic signaling. Here, the illustrated user interface subsystem includes a display and speakers. While not shown, input may also be interpreted from touchscreen gestures, button presses, device motion, and/or commands (verbally spoken). The user interface subsystem may include physical components (e.g., buttons, keyboards, switches, scroll wheels, etc.) or virtualized components (via a touchscreen).

A display presents images and/or video to a user. The display renders an array of pixels, each pixel having a corresponding luminance and color. Displays also periodically refresh the image data at a specified refresh rate; the refresh rate enables both video (moving images) and static image displays. As previously alluded to, image data is generally too large to be stored and/or transmitted in this format. Instead, the image data is encoded and compressed for storage/transfer, and then decoded and decompressed for presentation.

The decoding and decompression process inverts (reverses) the process of encoding and compression. Thus, for example, video that has been encoded with the Discrete Cosine Transform (DCT) uses an Inverse DCT (IDCT). In other words, most MPEG standards reconstruct image blocks/macroblocks from the DCT frequency coefficients. Much like DCT, IDCT can be implemented with different twiddle factors.

A speaker reproduces acoustic sound for a user. Typically, an audio driver converts encoded audio media into frequency information that is used to generate electrical waveforms. The waveforms are amplified and converted into mechanical motion drive a speaker at the desired frequencies. The resulting vibrations compress air to create acoustic waves that can be heard by the human ear. Much like video codecs, audio codecs rely on Inverse FFT (IFFT) and/or Inverse DFT (IDFT) to generate the resulting waveforms.

While present disclosure is described in the context of IDCTs, IFFTs, and IDFTs, the techniques may be applied to other inverse transforms including without limitation: wavelet-based transforms, etc.

Various embodiments of the machine learning subsystem 1400 may provide media data to the user interface subsystem 1100 for presentation. In other words, the machine learning subsystem may perform signal processing in one domain and take the additional step of inverting data for user interface subsystems (e.g., IDCT, IDFT, IFFT, etc.) In one embodiment, the media data may include time-domain samples. For example, audio data may be transferred directly as audio samples which may be directly used to drive a speaker. In other embodiments, the media data may include spatial-domain samples. For example, image data may be used to directly drive the row and column drivers of a display.

Other embodiments may further incorporate the techniques within so-called “overlap add” processing (OLA) which is an efficient technique for evaluating a discrete convolution of a large signal with a finite impulse response (FIR) filter. OLA processing is often used in hearing aids and audio processing to resynthesize audio in real-time. Other examples of OLA are e.g., equalization, notch-filtering, and adaptive filtering (e.g. for feedback cancellation). Wide Dynamic Range Compression (WDRC) is another example of non-linear processing which could benefit from such techniques; WDRC is typically performed in the audio signal chain, sandwiched between the FFT and IFFT.

### Data and Network Interface Subsystem

Functionally, the data and network interface subsystem 1200 transmits and/or receives data to other machines. Here, the data and network interface subsystem includes radio(s), modem(s), and antenna(s). Other implementations may include wired interfaces and/or removeable media interfaces (e.g., SD cards, Flash Drives, etc.).

As a brief aside, radio(s), modem(s), and antenna(s) are often used to provide wireless connectivity. Wi-Fi and cellular modems are often used for communication over long distances. Many embedded devices use Bluetooth Low Energy (BLE), Internet of Things (IoT), ZigBee, LoRa WAN(Long Range Wide Area Network), NB-IoT (Narrow Band IoT), and/or RFID type interfaces. Still other network connectivity solutions may be substituted with equal success, by artisans of ordinary skill given the contents of the present disclosure.

Many modern wireless modems are heavily based on signal processing techniques. For example, Orthogonal Frequency Division Multiple Access (OFDMA) is a multiple access technique used in wireless communication systems, particularly in the context of modern cellular networks like LTE (Long-Term Evolution) and 5G. In OFDMA, the available spectrum is divided into multiple subcarriers which change across time slots (time-frequency resources).

In the forward link, the base station assigns data symbols for each user to frequency subcarriers; the set of data symbols are modulated (DFT) into waveforms which are then transmitted as a radio frequency (RF) signal for each time slot. Each user receives the RF signal and demodulates the signal (IDFT). In addition to the physical air interface, a variety of other codecs and/or signal processing may also be used for signal processing of the data symbols. For example, encryption and encoding ensure that each user may only recover their own data symbols.

In the reverse link, the user device may modulate and transmit information to the base station using single carrier frequency division multiple access (SC-FDMA)-which generates the subcarriers for just the user's allocated transmit resources. The base station receives the aggregate user symbols and performs the corresponding demodulation (IDFT) to recover each user's transmitted symbols.

While present disclosure is described in the context of OFDMA, IDFTs, DFTs, and SC-FDMA, the techniques may be applied to other radio interfaces with equal success.

Various embodiments of the machine learning subsystem 1400 may receive and/or process network data from/to the data and network interface subsystem 1200. In other words, the machine learning subsystem may perform modulation and/or demodulation to recover network data. Such implementations may operate in parallel with, or independent from, other components of the data and network interface subsystem 1200 as well as the control and data subsystem 1300.

In some embodiments, machine-specific wireless applications may run independently of, or in conjunction with, other user activity. For example, the machine learning subsystem may “sniff” ongoing network traffic and/or communicate directly with the base station. As but another example, the machine learning subsystem may be able to identify network conditions to wake up the rest of the user device (e.g., without running the full modem, booting a high-level operating system, etc.).

### Control and Data Subsystem

The following discussion provides a specific discussion of the internal operations, design considerations, and/or alternatives, for the control and data subsystems 1300 which may include a central processing unit (CPU) and memory (also referred to throughout as non-transitory computer-readable medium).

Processors execute a set of instructions to manipulate data and/or control a device. Artisans of ordinary skill in the related arts will readily appreciate that the techniques described throughout are not limited to the basic processor architecture and that more complex processor architectures may be substituted with equal success. Different processor architectures may be characterized by e.g., pipeline depths, parallel processing, execution logic, multi-cycle execution, and/or power management, etc.

Typically, a processor executes instructions according to a clock. During each clock cycle, instructions propagate through a “pipeline” of processing stages; for example, a basic processor architecture might have: an instruction fetch (IF), an instruction decode (ID), an operation execution (EX), a memory access (ME), and a write back (WB). During the instruction fetch stage, an instruction is fetched from the instruction memory based on a program counter. The fetched instruction may be provided to the instruction decode stage, where a control unit determines the input and output data structures and the operations to be performed. In some cases, the result of the operation may be written to a data memory and/or written back to the registers or program counter. Certain instructions may create a non-sequential access which requires the pipeline to flush earlier stages that have been queued, but not yet executed. Exemplary processor designs are also discussed within U.S. patent application Ser. No. 17/367,517 filed Jul. 5, 2021, and entitled “METHODS AND APPARATUS FOR MATRIX AND VECTOR STORAGE AND OPERATIONS”, and U.S. patent application Ser. No. 17/367,521 filed Jul. 5, 2021, and entitled “METHODS AND APPARATUS FOR THREAD-BASED SCHEDULING IN MULTICORE NEURAL NETWORKS”, previously incorporated by reference in their entireties.

As a practical matter, different processor architectures attempt to optimize their designs for their most common usages. More specialized logic can often result in much higher performance (e.g., by avoiding unnecessary operations, memory accesses, and/or conditional branching). For example, an embedded device may have a processor core to control device operation and/or perform tasks of arbitrary complexity/best-effort. This may include, without limitation: a real-time operating system (RTOS), memory management, etc. Typically, such CPUs are selected to have relatively short pipelining, longer words (e.g., 32-bit, 64-bit, and/or super-scalar words), and/or addressable space that can access both local cache memory. More directly, the processor may often switch between tasks, and must account for branch disruption and/or arbitrary memory access.

Other processor subsystem implementations may multiply, combine, further subdivide, augment, and/or subsume the foregoing functionalities within other processing elements. For example, machine learning subsystem 1400 (described below) may be used to accelerate specific tasks (e.g., a sparse matrix processing of a neural network, etc.).

Referring back to FIG. 9, the memory (non-transitory computer-readable medium) may be used to store data. In one exemplary embodiment, data may be stored as non-transitory symbols (e.g., bits, bytes, words, and/or other data structures.) In one specific implementation, the memory subsystem is realized as one or more physical memory chips (e.g., NAND/NOR flash) that are logically separated into memory data structures. The memory subsystem may be bifurcated into program code (e.g., a partitioning routine and/or other operational routines) and/or program data (e.g., neural network configurations). In some variants, program code and/or program data may be further organized for dedicated and/or collaborative use. For example, a processor may share a common memory buffer with one or more other peripherals to facilitate large transfers of data.

Program code is implemented as computer-readable instructions that when executed by the processor cause the processor to perform tasks. Examples of such tasks may include: configuration of other logic (e.g., the machine learning subsystem 1400), memory mapping of the memory resources, and control/articulation of the other peripherals (if present). In some embodiments, the program code may be statically stored within the apparatus as firmware. In other embodiments, the program code may be dynamically stored (and changeable) via software updates. In some such variants, software may be subsequently updated by external parties and/or the user, based on various access permissions and procedures.

### Machine Learning Subsystem

The following discussion provides a specific discussion of the internal operations, design considerations, and/or alternatives, for the machine learning subsystem 1400. Here, “machine learning” refers to computing techniques that “learn” to perform specific tasks through observation and inference rather than explicit examples. Neural networks are one type of machine learning techniques. Here, a sparse matrix processor is used to emulate a neural network of logical nodes.

As a brief aside, there are many different types of parallelism that may be leveraged in neural network processing. Data-level parallelism refers to operations that may be performed in parallel over different sets of data. Control path-level parallelism refers to operations that may be separately controlled. Thread-level parallelism spans both data and control path parallelism; for instance, two parallel threads may operate on parallel data streams and/or start and complete independently. Parallelism and its benefits for neural network processing are described within U.S. patent application Ser. No. 17/367,521 filed Jul. 5, 2021, and entitled “METHODS AND APPARATUS FOR THREAD-BASED SCHEDULING IN MULTICORE NEURAL NETWORKS”, previously incorporated by reference in its entirety.

The sparse matrix processor leverages thread-level parallelism and asynchronous handshaking to decouple sub-core-to-sub-core data path dependencies of the neural network. In other words, neural network threads run independently of one another, without any centralized scheduling and/or resource locking (e.g., semaphore signaling, critical path execution, etc.). Decoupling thread dependencies allows sub-cores to execute threads asynchronously. In one specific implementation, the thread-level parallelism uses packetized communication to avoid physical connectivity issues (e.g., wiring limitations), computational complexity, and/or scheduling overhead.

Translation logic is glue logic that translates the packet protocol natively used by the sub-cores to/from the system bus protocol. A “bus” refers to a shared physical interconnect between components; e.g., a “system bus” is shared between the components of a system. A bus may be associated with a bus protocol that allows the various connected components to arbitrate for access to read/write onto the physical bus. As used herein, the term “packet” refers to a logical unit of data for routing (sometimes via multiple “hops”) through a logical network—e.g., a logical network may span across multiple physical busses. The packet protocol refers to the signaling conventions used to transact and/or distinguish between the elements of a packet (e.g., address, data payload, handshake signaling, etc.).

To translate a packet to a system bus transaction, the translation logic converts the packet protocol information into physical signals according to the bus protocol. For example, the packet address data may be logically converted to address bits corresponding to the system bus (and its associated memory map). Similarly, the data payload may be converted from variable bit widths to the physical bit width of the system bus; this may include concatenating multiple payloads together, splitting payloads apart, and/or padding/deprecating data payloads. Control signaling (read/write) and/or data flow (buffering, ready/acknowledge, etc.) may also be handled by the translation logic.

To convert a system bus transaction to packet data, the process may be logically reversed. In other words, physical system bus data is read from the bus and written into buffers to be packetized. Arbitrarily sized data can be split into multiple buffers and retrieved one at a time or retrieved using “scatter-gather” direct memory access (DMA). “Scatter-gather” refers to the process of gathering data from, or scattering data into, a given set of buffers. The buffered data is then subdivided into data payloads, and addressed to the relevant logical endpoint (e.g., a sub-core of the neural network).

While the present discussion describes a packet protocol and a system bus protocol, the principles described throughout have broad applicability to any communication protocol. For example, some devices may use multiple layers of abstraction to overlay a logical packet protocol onto a physical bus (e.g., Ethernet), such implementations often rely on a communication stack with multiple distinct layers of protocols (e.g., a physical layer for bus arbitration, and a network layer for packet transfer, etc.).

As shown, each sub-core of the neural network includes its own processing hardware, local weights, global weights, working memory, and accumulator. These components may be generally re-purposed for other processing tasks. For example, memory components may be aggregated together to a specified bit width and memory range (e.g., a 1.5 Mb of memory could be re-mapped to an addressable range of 24K with 64 bit words, 48K with 32 bit words, etc.). In other implementations, processing hardware may provide, e.g., combinatorial and/or sequential logic, processing components (e.g., arithmetic logic units (ALUs), multiply-accumulates (MACs), etc.).

The exemplary sub-core designs have been optimized for neural network processing, however this optimization may be useful in other ways as well. For example, the highly distributed nature of the sub-cores may be useful to provide RAID-like memory storage (redundant array of independent disks), offering both memory redundancy and robustness. Similarly, the smaller footprint of a sub-core and its associated memory may be easier to floorplan and physically “pepper-in-to” a crowded SoC die compared to a single memory footprint.

As previously noted, each sub-core has its own corresponding router. Data may be read into and/or out of the sub-core using the packet protocol. While straightforward implementations may map a unique network address to each sub-core of the pool, packet protocols allow for a single entity to correspond to multiple logical entities. In other words, some variants may allow a single sub-core to have a first logical address for its processing hardware, a second logical address for its memory, etc.

More directly, artisans of ordinary skill in the related arts given the contents of the present disclosure will readily appreciate that the logical nature of packet-based communication allows for highly flexible logical partitioning. Any sub-core may be logically addressed as (one or more of) a memory sub-core, a neural network sub-core, or a reserved sub-core. Furthermore, the logical addressing is not fixed to the physical device construction and may be changed according to a compile-time, run-time, or even program-time considerations.

### Generalized Sparse Matrix Transform

In one generalized aspect, the control and data subsystem may configure one or more of the sub-cores to perform a sparse matrix transform. Specifically, the sparse matrix transform leverages the sparse matrix processor of the sub-core to perform sparse matrix operations that are mathematically equivalent to a signal processing transform. Importantly, this operation may be performed before, after, integrally within, and potentially entirely separate of any neural network processing or other machine learning tasks.

While the foregoing discussion presents transforms as inputs/outputs to the neural network for ease of illustration, the techniques may have significant applications for transforms within the neural network itself. For example, one-dimensional (1D) and two-dimensional (2D) convolutions with larger kernel-sizes can be translated to much more efficient element-wise multiplication in the Fourier domain, with sufficient padding to ensure that the convolutions remain acyclic. Similarly, emerging linear state-space models (e.g., S4, S4D, and LRU) can be much more efficiently applied to long-sequences via translation to the Fourier domain. This is possible due to the mathematical equivalence between linear state-space models and long-kernel convolutions (in this case, the convolutional kernel would have the same length as the input data). More generally, any representation of a linear state-space model as a convolution with a very large kernel size (e.g. the full length of the sequence) can be significantly improved in terms of speed and computational efficiency.

In one embodiment, the sparse matrix processor includes data addressing logic that is configured to represent and/or address sparse data structures based on their null and/or non-null content. For example, various implementations may store sparse vectors as a “pencil” data structure and/or sparse matrices as multiple one-dimensional sparse column arrays. As previously noted, null data is treated differently than non-null data; null data (“.”) may be skipped, whereas non-null data (e.g., “0”, “1”, etc.) is calculated. The sparse matrix processor may leverage the null/non-null distinction to perform sparse matrix operations differently; in particular, instead of computing vector and/or matrix operations on an element-wise basis, null values, arrays, and/or groups of arrays may be entirely skipped.

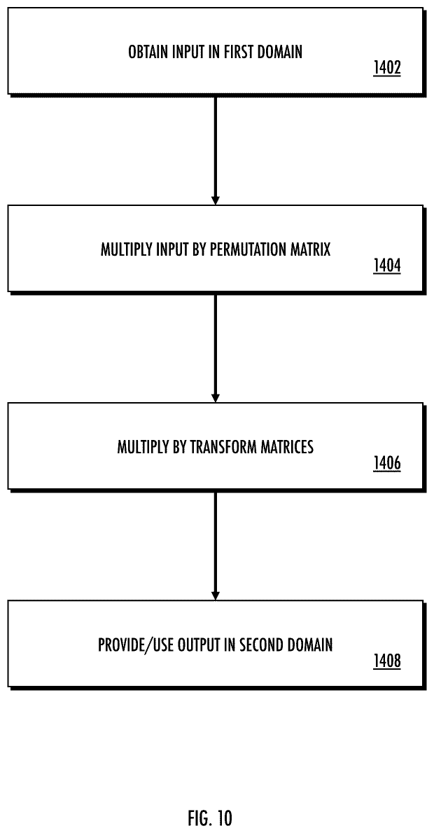

FIG. 10 is a logical block diagram of a generalized sparse matrix transform routine. In one specific embodiment, the sparse matrix processor executes a sparse matrix transform routine that: obtains a first domain input; multiplies the first domain input by a permutation matrix to provide a bit-reversed input; and multiplies the bit-reversed input by transform matrices to obtain a second domain output. In some variants, the second domain output may be used for a neural network operation; in other variants, the second domain output may be provided to another component. The following discussion provides a specific discussion of the steps performed during the sparse matrix transform routine.

At step 1002, the sparse matrix processor obtains a first domain input. Here, the input data may be obtained from a shared bus, such as a data bus shared by multiple cores of a system-on-a-chip. In some cases, the shared bus may use a shared bus protocol (e.g., packet-based, bus arbitration, etc.). In some such implementations, the data may additionally be packetized for delivery via a network of nodes (other sub-cores).

In other embodiments, the input data may be obtained from a dedicated bus or other point-to-point connection. In some cases, a dedicated bus may allow for direct access (e.g., direct memory access) and/or specialized bitwidths, data protocols, etc. Dedicated bus access may be useful for extreme low power applications, performance, and/or other special use applications.

In some embodiments, the input signal may be a time-domain input. Examples may include e.g., audio samples, RF samples, and/or other electrical signaling. Other implementations may use spatial-domain input (e.g., images, maps, 2-dimensional arrays, etc.).

Various embodiments may read or “pull” data from other components. For example, a sparse matrix processor may pull data from the host, memory, or other component. In other embodiments, the components may write or “push” data to the machine learning subsystem. For example, a sensor may wake the sparse matrix processor to push data to it. Still other embodiments may use polling mechanisms and/or mailbox interrupt-style notifications. A variety of other data transfer technologies may be substituted with equal success.

At step 1004, the sparse matrix processor multiplies the first domain input by a permutation matrix to provide a bit-reversed input. In one exemplary embodiment, a single permutation matrix based on the size of the input data. For example, an input that is 8-elements long may be handled with an 8×8 permutation matrix (single stage decomposition), an input that is 16-elements long may be handled with a 16×16 permutation matrix (two-stage decomposition), an input that is 32-elements long may be handled with a 32×32 permutation matrix (three-stage decomposition), etc.

As demonstrated elsewhere, the single permutation matrix is a sparse matrix, which may be represented as a multiple one-dimensional sparse column arrays. In one embodiment, the product of the input vector and the single permutation matrix is performed by skipping null entries, greatly reducing the overall computational complexity.

While the foregoing examples are presented in the context of power-of-two input, artisans of ordinary skill will readily appreciate that the modulo-k subvector notation may be broadly extended to generate the permutation matrix for bit-reversed addressing of any arbitrary length (i.e., x_{a mod k}, where the index (i) for size (k) has a modulo remainder (a)—here, the modulo remainder is used for the bit-reversed ordering).

At step 1006, the sparse matrix processor multiplies the bit-reversed input by transform matrices to obtain a second domain output. In one exemplary embodiment, the number of transform matrices is based on the size of the input data. For example, an input that is 8-elements long may be handled with three matrix operations (corresponding to different scales of butterfly operations and their associated twiddle factors). An input that is 16-elements long may be handled with four matrix operations, etc. Each of the transform matrices are also sparse matrices, which may be represented as a multiple one-dimensional sparse column arrays. In one embodiment, the product of the input vector and the single permutation matrix is performed by skipping null entries, greatly reducing the overall computational complexity.

As previously noted, different transforms may use different twiddle factors. For example, a Fast Fourier Transform (FFT), a Discrete Fourier Transform (DFT), and a Discrete Cosine Transform (DCT) may each have different formulations for twiddle factors that are well known in the signal processing arts.

Furthermore, while the foregoing examples are presented in the context of power-of-two input, artisans of ordinary skill will readily appreciate that the twiddle factors and butterfly operations may be broadly extended to any arbitrary length, consistent with other non-power-of-two DFT implementations. More generally, artisans of ordinary skill in the related arts will readily appreciate that any signal processing technique that may be expressed as a sparse matrix operation may benefit from the techniques described herein.

While the foregoing examples are presented in the context of a first domain and a second domain, artisans of ordinary skill in the related arts will further appreciate that other applications may operate wholly within a single domain. For example, certain types of filter operations may be expressed as a sparse matrix operation. Similarly, linear mappings commonly used in the image signal processing (ISP) arts may also benefit from the techniques described throughout (e.g., color balance, white balance, etc.)

At step 1008, the second domain output may be provided/used. In one exemplary embodiment, the second domain output may be directly used by the sparse matrix processor for another action (e.g., neural network processing, etc.). In other embodiments, the second domain output may be provided to another component (e.g., to enable a thread on a different core, for use on the host processor, presentation by the user interface, transmission via a modem, etc.).

It will be appreciated that the various ones of the foregoing aspects of the present disclosure, or any parts or functions thereof, may be implemented using hardware, software, firmware, tangible, and non-transitory computer-readable or computer usable storage media having instructions stored thereon, or a combination thereof, and may be implemented in one or more computer systems.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

What is claimed is:

1. A method for accelerating transforms via sparse matrix operations, comprising:
obtaining a first domain input having a length;
multiplying the first domain input by a single permutation matrix to provide a bit-reversed input; and
multiplying the bit-reversed input by a first number of transform matrices to obtain a second domain output.

2. The method of claim 1, where the single permutation matrix is based on the length of the first domain input and a number of decomposition stages.

3. The method of claim 2, where the single permutation matrix comprises one or more consecutive sets of non-null values and one or more consecutive sets of null values;
where multiplying the first domain input by the single permutation matrix further comprises:
calculating at least one product based on the one or more consecutive sets of non-null values; and
skipping the one or more consecutive sets of null values.

4. The method of claim 1, where the first number of transform matrices are based on the length.

5. The method of claim 1, where the first domain input is obtained from a data bus shared by multiple cores of a system-on-a-chip, and the second domain output is stored to a dedicated memory of a first core of the system-on-a-chip.

6. The method of claim 1, where the first domain input comprises an audio signal and the first number of transform matrices are mathematically equivalent to a Discrete Fourier Transform (DFT).

7. The method of claim 1, where the first domain input comprises a video signal and the first number of transform matrices are mathematically equivalent to a Discrete Cosine Transform (DCT).

8. A system-on-a-chip, comprising:
a system bus;
a sensor interface coupled to the system bus, the sensor interface configured to receive a first domain input from a sensor;
a first processor core coupled to the system bus;
a neural network core coupled to the system bus;
where the neural network core is partitioned into a set of sub-cores; and
where a first sub-core comprises logic configured to:
obtain the first domain input from the sensor interface via the system bus;
multiply the first domain input by a single permutation matrix to provide a bit-reversed input; and
multiply the bit-reversed input by a first number of transform matrices to obtain a second domain output.

9. The system-on-a-chip of claim 8, where each sub-core of the neural network core is configured to independently execute a corresponding set of threads, and where the second domain output enables a thread on an other sub-core of the neural network core.

10. The system-on-a-chip of claim 8, where the first sub-core further comprises logic configured to calculate a neural network activation based on the second domain output and transmit the neural network activation to the first processor core.

11. The system-on-a-chip of claim 8, where the single permutation matrix or the first number of transform matrices comprise one or more consecutive sets of non-null values and one or more consecutive sets of null values, and where the first sub-core further comprises logic configured to:
calculate at least one product based on the one or more consecutive sets of non-null values; and
skip the one or more consecutive sets of null values.

12. The system-on-a-chip of claim 8, where the first sub-core further comprises logic configured to transmit the second domain output to the first processor core.

13. The system-on-a-chip of claim 8, where the sensor comprises a microphone and the first number of transform matrices are mathematically equivalent to a Discrete Fourier Transform (DFT).

14. The system-on-a-chip of claim 8, where the sensor comprises a camera and the first number of transform matrices are mathematically equivalent to a Discrete Cosine Transform (DCT).

15. A sparse matrix processor, comprising:
address logic configured to represent sparse matrix data structures as one or more consecutive sets of non-null values and one or more consecutive sets of null values; and
transform logic configured to perform a signal processing transform as a set of sparse matrix operations, where the transform logic is configured to skip operations with at least one null value.

16. The sparse matrix processor of claim 15, where the set of sparse matrix operations comprises a multiplication based on a permutation matrix.

17. The sparse matrix processor of claim 16, where the permutation matrix has a plurality of consecutive sets of null values.

18. The sparse matrix processor of claim 15, where the set of sparse matrix operations comprises one or more multiplications based on a number of transform matrices.

19. The sparse matrix processor of claim 18, where each transform matrix of the number of transform matrices comprise one or more twiddle coefficients.

20. The sparse matrix processor of claim 15, where the signal processing transform is a Fast Fourier Transform (FFT), a Discrete Fourier Transform (DFT), or a Discrete Cosine Transform (DCT).
